(19) United States
(12) Patent Application Publication
(10) Pub. No.: US 2017/0193458 A1
(43) Pub. Date: Jul. 6, 2017

(54) SYSTEM FOR PROVIDING FUTURE TRANSPORTATION REQUEST RESERVATIONS

(71) Applicant: Juno Lab, Inc., Tortola (VG)

(72) Inventors: Talmon Marco, Tel Aviv (IL); Igor Magazinik, Ramat Gan (IL)

(21) Appl. No.: 14/985,599

(22) Filed: Dec. 31, 2015

(51) Int. Cl. G06Q 10/10; G06Q 10/02; G06Q 30/06

(52) U.S. Cl. CPC G06Q 10/1097; G06Q 30/0611; G06Q 10/02

(57) ABSTRACT

In one embodiment, there is provided a method including: receiving, at a server comprising at least one processor and at least one network interface to communicatively couple the processor to a network, a request from a computing device of a passenger for a trip, the request including a desired future pickup time at a location; computing a predicted availability of a driver for the future pickup time; and dispatching the driver to the location to arrive at approximately the pickup time. There is also provided an apparatus for providing the method, and one or more tangible, non-transitory computer-readable mediums having stored thereon executable instructions for providing the method.

### TECHNICAL FIELD

This disclosure relates in general to the field of mobile applications and, more particularly, to a system and method for providing future transportation request reservations.

### BACKGROUND

A transportation service may utilize a plurality of drivers that fulfill passenger requests for transportation. A transportation service may provide one or more mobile applications that facilitate the efficient pairing of passengers and drivers. The transportation service may receive a transportation request and select a driver to fulfill the request based on information associated with the transportation request and information associated with the driver.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a block diagram of a system for providing future transportation request reservations in accordance with certain embodiments.

FIG. 2 illustrates a block diagram of a passenger computing device and a driver computing device of the system of FIG. 1 in accordance with certain embodiments.

FIG. 3 illustrates a block diagram of a backend system of the system of FIG. 1 in accordance with certain embodiments.

FIG. 4 illustrates a geographical region divided into a plurality of zones in accordance with certain embodiments.

FIG. 5 is a flow chart of a user providing a future reservation request in accordance with certain embodiments.

FIG. 6 is a flow chart of a backend server providing a reservation in accordance with certain embodiments.

FIG. 7 is a flow chart of a backend server providing a reservation in accordance with certain embodiments.

### DETAILED DESCRIPTION OF EXAMPLE EMBODIMENTS

### Overview

In one embodiment, there is provided a method including: receiving, at a server comprising at least one processor and at least one network interface to communicatively couple the processor to a network, a request from a computing device of a passenger for a trip, the request including a desired future pickup time at a location; computing a predicted availability of a driver for the future pickup time; and dispatching the driver to the location to arrive at approximately the pickup time. There is also provided an apparatus for providing the method, and one or more tangible, non-transitory computer-readable mediums having stored thereon executable instructions for providing the method.

### Example Embodiments

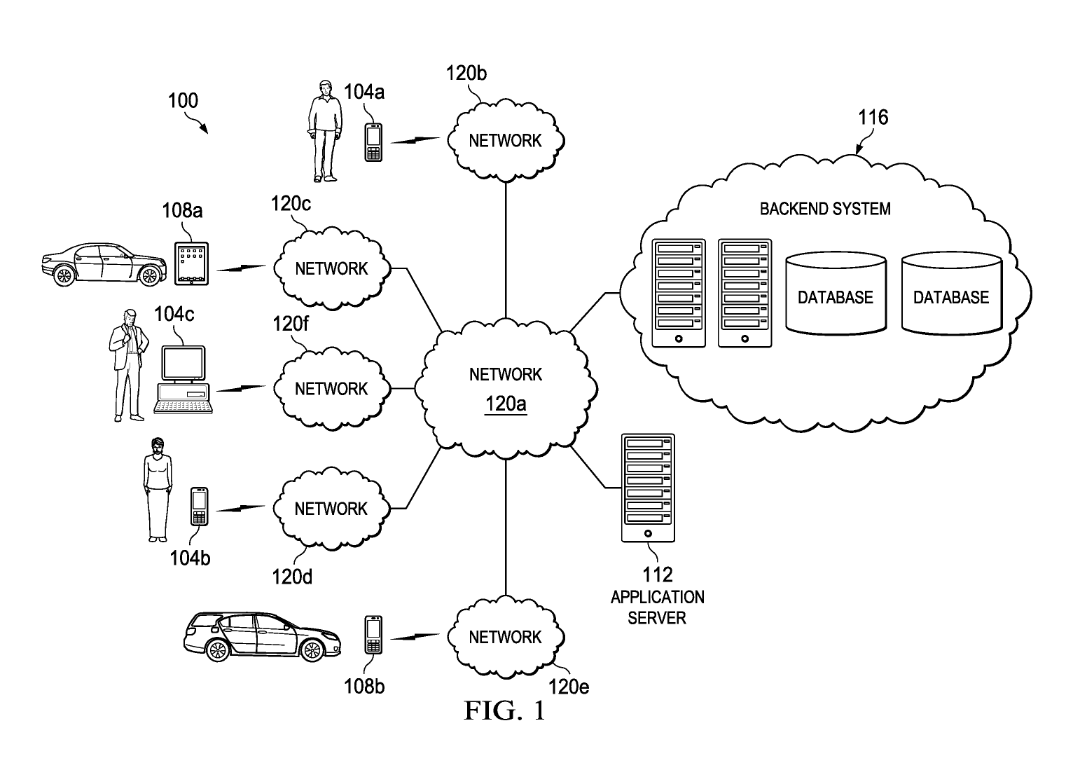

FIG. 1 illustrates a block diagram of a system 100 for providing future reservations in accordance with certain embodiments. Although various embodiments may include any number of drivers, passengers, and associated devices, system 100 depicts three passengers having associated passenger computing devices 104 and two drivers having associated driver computing devices 108. The computing devices are coupled through various networks 120 to an application server 112 and a backend system 116.

Various embodiments of the present disclosure may enhance the experience of passengers and drivers associated with a transportation service by providing future transportation request reservations to passengers. Various embodiments may provide technical advantages such as minimizing fuel or power used to service transportation requests, more efficient use of computing and communication resources to route drivers to passengers, and other technical advantage.

Computing devices 104 and 108 may include any electronic computing device operable to receive, transmit, process, and store any appropriate data. In various embodiments, computing devices 104 and 108 may be mobile devices or stationary devices. As examples, mobile devices may include laptop computers, tablet computers, smartphones, personal digital assistants, smartwatches, computers integrated with a vehicle, computers integrated with clothing, and other devices capable of connecting (e.g., wirelessly) to one or more networks 120 while stationary devices may include desktop computers, televisions, or other devices that are not easily portable. Devices 104 and 108 may include a set of programs such as operating systems (e.g., Microsoft Windows, Linux, Android, Mac OSX, Apple iOS, UNIX, or similar operating system), applications, plug-ins, applets, virtual machines, machine images, drivers, executable files, and other software-based programs capable of being run, executed, or otherwise used by the respective devices. Each computing device can include at least one graphical display and user interface allowing a user to view and interact with applications and other programs of the computing device. In a particular embodiment, computing device 108 may be a hardened device that is configured to only run a driver application using a specialized operating system (e.g., a modified version of Android). In one embodiment, a transportation service may issue or otherwise facilitate the provision of hardened devices to its drivers, but restrict the functionality of the devices to the driver application (i.e., the devices may be locked down so as not to allow the installation of additional applications or may only allow preapproved applications to be installed).

In various embodiments, a driver computing device 108 may be integrated within and/or communicate with a self-driven vehicle (e.g., a vehicle that has the capability of driving without physical steering guidance from a human being) and may influence the movement of the vehicle by providing route information (e.g., passenger pick-up and destination locations driver destination locations, navigational directions, etc.) to the self-driven vehicle. Accordingly, as used herein “driver” may refer to a human being that may physically drive or otherwise control movement of a vehicle or to the vehicle itself (e.g., in the case of a self-driven vehicle) or component thereof (e.g., computing device application 108 or logic thereof).

In particular embodiments, a passenger application runs on passenger computing devices 104. The application may allow a user to enter various account information (e.g., in connection with a registration with the transportation service) to be utilized by a transportation service. For example, the account information may include a user name and password (or other login credentials), contact information of the user (e.g., phone number, home address), payment information (e.g., credit card numbers or bank account numbers and associated information), or car preference information (e.g., what models or color of car the user prefers).

The application may allow a user to request a ride from the transportation service. In various embodiments, the application may establish a pick-up location automatically or based on user input (e.g., locations may include the current location of the computing device 104 as determined by a global positioning system (GPS) of the computing device or a different user-specified location). In certain embodiments, the user may specify a destination location as well. The locations may be specified in any suitable format, such as GPS coordinates, street address, establishment name (e.g., LaGuardia Airport, Central Park, etc.), or other suitable format. At any time (e.g., before the ride, during the ride, or after the ride is complete) the user may specify a method of payment to be used for the ride. The user may also specify whether the request is for immediate pick-up or for a specified time in the future. In various embodiments, the user may specify pick-up by a vehicle that has particular merchandise available for use by the user, such as a specified type of battery charger, bottle of water or other food or beverage, umbrella, or other suitable merchandise. The user may also specify criteria for the driver, such as a minimum performance rating, such that drivers having performance ratings below the minimum performance rating will not be considered during selection of the driver.

The user may use the application to order a ride based on the specified information. The request for the ride is generated based on the information and transmitted to backend system 116. Backend system 116 will facilitate the selection of a driver. In some embodiments, backend system 116 may select a driver based on any suitable factors, such as the information contained in the request from the passenger, the proximity of the driver to the passenger, or other suitable factors. In other embodiments, backend system 116 may select a plurality of drivers that could fulfill the ride request, send information associated with the drivers to the passenger, and allow the passenger to select the driver to be used via the application on the passenger computing device 104. Any suitable information about the potential driver(s) may be sent to the computing device 104 either before or after the selection of the driver by the passenger, such as a location of a driver, an estimated pick-up time, a type of car used by a driver, the merchandise available in the car, driver ratings or comments from other passengers about the driver, or other suitable information.

Once a driver has been selected and has accepted the request to provide a ride, the application may notify the user of the selected driver and provide real-time updates of the driver's location (e.g., with respect to the passenger's location) and estimated pick-up time. The application may also provide contact information for the driver and/or the ability to contact the driver through the application (e.g., via a phone call or text). Once the ride has begun, the application may display any suitable information, such as the current location of the computing device 104 and the route to be taken. Upon completion of the ride, the application may provide the passenger the ability to rate the driver or provide comments about the driver.

In particular embodiments, a driver application runs on driver computing devices 108. The application may allow a driver to enter various account information to be utilized by a transportation service. For example, the account information may include a user name and password (or other login credentials), contact information of the driver (e.g., phone number, home address), information used to collect payment (e.g., bank account information), vehicle information (e.g., what model or color of car the driver utilizes), merchandise offered by the driver, or other suitable information.

In various embodiments, the application may allow a driver to specify his availability to transport passengers for the transportation service. In some embodiments, the driver may select between multiple levels of availability. In one example, the driver may be “available,” meaning that the driver is willing to receive and consider any transportation requests that the transportation service sends the driver; the driver may be “unavailable,” meaning that the driver is not willing to receive any transportation requests (e.g., this state may be explicitly indicated by the driver inputting this state into his computing device or may be detected through a deduction that the driver's device is not logged in to the transportation service through the driver application), or the driver may be “inactive,” meaning that the driver only desires to receive particular requests meeting certain exception criteria.

The application may periodically transmit the current location of the computing device 108 as determined by a GPS of the computing device 108 to the backend system 116. When a driver is selected to provide (or identified as a suitable candidate for) a ride, backend system 116 may send a notification to the driver application. In some embodiments, the driver may have a limited amount of time to select whether the driver accepts the ride. In other embodiments, the application may be configured by the driver to automatically accept the ride or to automatically accept the ride if certain criteria are met (e.g., fare minimum, direction of travel, minimum passenger rating, etc.).

Once a pairing of the driver and the passenger is confirmed by backend system 116, the application may navigate the driver to the passenger. The application may also provide contact information for the passenger and/or the ability to contact the passenger through the application (e.g., via a phone call, email, instant message, or text). The application may also navigate the driver to the passenger's destination once the ride begins. Upon completion of the ride, the application may provide the driver the ability to rate the passenger or provide comments about the passenger.

System 100 may include one or more application servers 112 coupled to the computing devices through one or more networks 120. The passenger application and driver application may be supported with, downloaded from, served by, or otherwise provided through an application server 112 or other suitable means. In some instances, the applications can be downloaded from an application storefront onto a particular computing device using storefronts such as Google Android Market, Apple App Store, Palm Software Store and App Catalog, RIM App World, etc., or other sources. In various embodiments, the passenger application and driver application may be installed on their respective devices in any suitable manner and at any suitable time. As one example, a passenger application may be installed on a computing device as part of a suite of applications that are pre-installed prior to provision of the computing device to a consumer. As another example, a driver application may be installed on a computing device by a transportation service (or an entity that provisions computing devices for the transportation service) prior to the issuance of the device to a driver that is employed or otherwise associated with the transportation service.

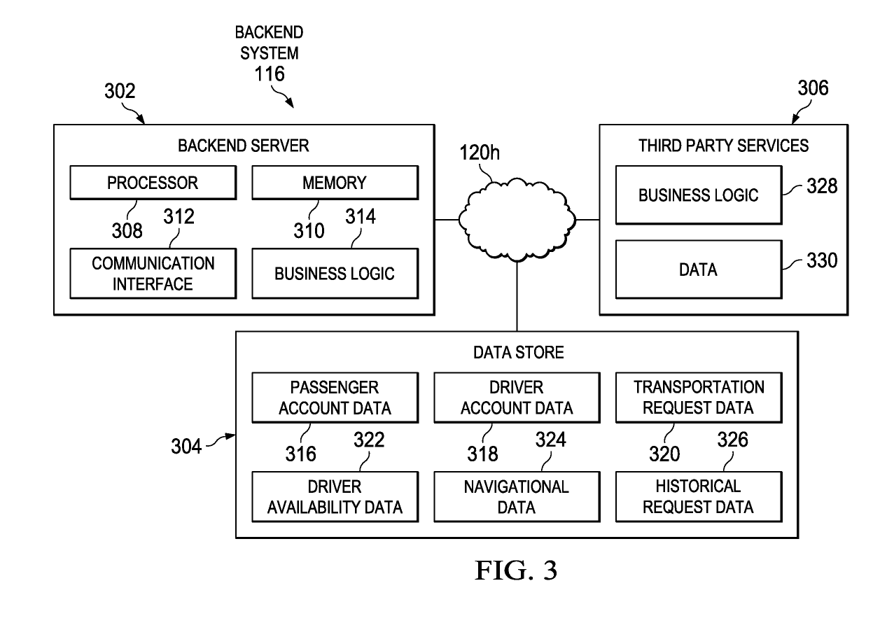

As described above, applications utilized by computing devices 104 and 108 can make use of a backend system 116. Backend system 116 may comprise any suitable servers or other computing devices that facilitate the provision of a transportation service as described herein. For example, backend system 116 may receive a request from a passenger and facilitate the assignment of a driver to fulfill the request. Backend system 116 is described in more detail in connection with FIG. 3.

In general, servers and other computing devices of backend system 116 or application server 112 may include electronic computing devices operable to receive, transmit, process, store, or manage data and information associated with system 100. As used in this document, the term “computing device,” is intended to encompass any suitable processing device. For example, portions of backend system 116 or application server 112 may be implemented using computers other than servers, including server pools. Further, any, all, or some of the computing devices may be adapted to execute any operating system, including Linux, UNIX, Windows Server, etc., as well as virtual machines adapted to virtualize execution of a particular operating system, including customized and proprietary operating systems.

Further, servers and other computing devices of system 100 can each include one or more processors, computer-readable memory, and one or more interfaces, among other features and hardware. Servers can include any suitable software component or module, or computing device(s) capable of hosting and/or serving a software application or services (e.g., services of application server 112 or backend system 116), including distributed, enterprise, or cloud-based software applications, data, and services. For instance, servers can be configured to host, serve, or otherwise manage data sets, or applications interfacing, coordinating with, or dependent on or used by other services, including transportation service applications and software tools. In some instances, a server, system, subsystem, or computing device can be implemented as some combination of devices that can be hosted on a common computing system, server, server pool, or cloud computing environment and share computing resources, including shared memory, processors, and interfaces.

In various embodiments, backend system 116 or any components thereof may be deployed using a cloud service such as Amazon Web Services, Microsoft Azure, or Google Cloud Platform. For example, the functionality of the backend system 116 may be provided by virtual machine servers that are deployed for the purpose of providing such functionality or may be provided by a service that runs on an existing platform.

System 100 also includes various networks 120 used to communicate data between the computing devices 104 and 108, the backend system 116, and the application server 112. The networks 120 described herein may be any suitable network or combination of one or more networks operating using one or more suitable networking protocols. A network may represent a series of points, nodes, or network elements and interconnected communication paths for receiving and transmitting packets of information. For example, a network may include one or more routers, switches, firewalls, security appliances, antivirus servers, or other useful network elements. A network may provide a communicative interface between sources and/or hosts, and may comprise any public or private network, such as a local area network (LAN), wireless local area network (WLAN), metropolitan area network (MAN), Intranet, Extranet, Internet, wide area network (WAN), virtual private network (VPN), cellular network (implementing GSM, CDMA, 3G, 4G, LTE, etc.), or any other appropriate architecture or system that facilitates communications in a network environment depending on the network topology. A network can comprise any number of hardware or software elements coupled to (and in communication with) each other through a communications medium. In some embodiments, a network may simply comprise a transmission medium such as a cable (e.g., an Ethernet cable), air, or other transmission medium.

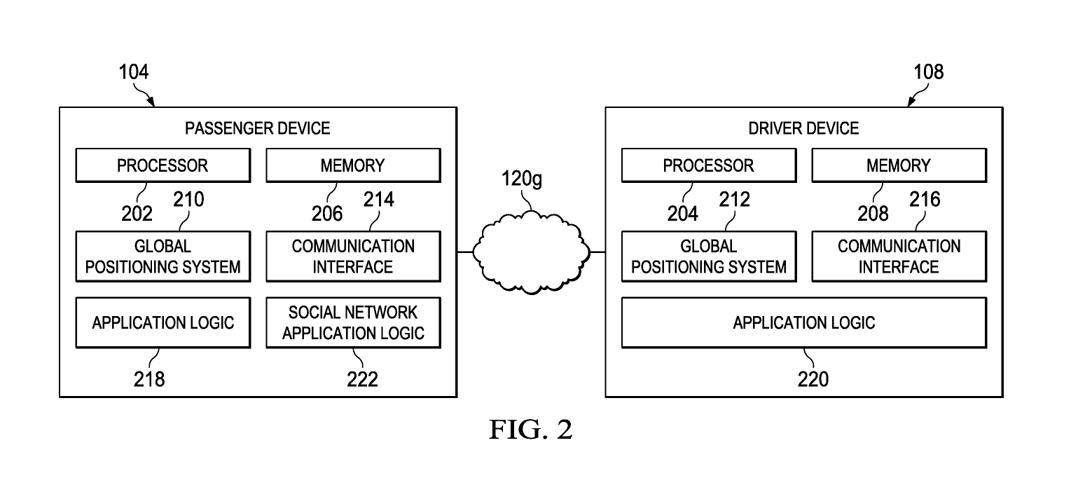

FIG. 2 illustrates a block diagram of a passenger computing device 104 and a driver computing device 108 of the system of FIG. 1 in accordance with certain embodiments. Herein, “passenger computing device” may be used to refer to a computing device used by a subscriber that has registered an account with the transportation service or other user who interacts with the transportation service (e.g., by communicating with the transportation service to request transportation) while “driver computing device” may be used to refer to a computing device used by a driver of the transportation service. In the embodiment shown, the devices may be communicatively coupled through network 120g which may include any suitable intermediary nodes, such as a backend system 116.

In the embodiment depicted, computing devices 104 and 108 each include a computer system to facilitate performance of their respective operations. In particular embodiments, a computer system may include a processor, storage, and one or more communication interfaces, among other components. As an example, computing devices 104 and 108 each include one or more processors 202 and 204, memory elements 206 and 208, and communication interfaces 214 and 216, among other hardware and software. These components may work together in order to provide functionality described herein.

A processors 202 or 204 may be a microprocessor, controller, or any other suitable computing device, resource, or combination of hardware, stored software and/or encoded logic operable to provide, either alone or in conjunction with other components of computing devices 104 and 108, the functionality of these computing devices. In particular embodiments, computing devices 104 and 108 may utilize multiple processors to perform the functions described herein.

A processor can execute any type of instructions to achieve the operations detailed in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array (FPGA), an erasable programmable read only memory (EPROM), an electrically erasable programmable ROM (EEPROM)) or an application specific integrated circuit (ASIC) that includes digital logic, software, code, electronic instructions, or any suitable combination thereof.

Memory 206 and 208 may comprise any form of non-volatile or volatile memory including, without limitation, random access memory (RAM), read-only memory (ROM), magnetic media (e.g., one or more disk or tape drives), optical media, solid state memory (e.g., flash memory), removable media, or any other suitable local or remote memory component or components. Memory 206 and 208 may store any suitable data or information utilized by computing devices 104 and 108, including software embedded in a computer readable medium, and/or encoded logic incorporated in hardware or otherwise stored (e.g., firmware). Memory 206 and 208 may also store the results and/or intermediate results of the various calculations and determinations performed by processors 202 and 204.

Communication interfaces 214 and 216 may be used for the communication of signaling and/or data between computing devices 104 and 108 and one or more networks (e.g., 120g) and/or network nodes (e.g., backend system 116 and application server 112) coupled to a network or other communication channel. For example, communication interfaces 214 and 216 may be used to send and receive network traffic such as data packets. Each communication interface 214 and 216 may send and receive data and/or signals according to a distinct standard such as an LTE, IEEE 802.11, IEEE 802.3, or other suitable standard. In various embodiments, any of the data described herein as being communicated between elements of system 100 may be data generated using voice commands from a user or data generated independently of voice commands (e.g., data may be generated by a processor in response to the processor receiving data from another element or from an input device such as a touch screen). Communication interfaces 214 and 216 may include antennae and other hardware for transmitting and receiving radio signals to and from other devices in connection with a wireless communication session over one or more networks 120.

GPS units 210 and 212 may include any suitable hardware and/or software for detecting a location of their respective computing devices 104 and 108. For example, a GPS unit may comprise a system that receives information from GPS satellites, wireless or cellular base stations, and/or other suitable source and calculates a location based on this information (or receives a calculated position from a remote source). In one embodiment, the GPS unit is embodied in a GPS chip.

Application logic 218 may include logic providing, at least in part, the functionality of the passenger application described herein. Similarly, application logic 220 may include logic providing, at least in part, the functionality of the driver application described herein. In a particular embodiment, the logic of devices 104 and 108 may include software that is executed by processor 202 and 204. However, “logic” as used herein, may include but not be limited to hardware, firmware, software and/or combinations of each to perform a function(s) or an action(s), and/or to cause a function or action from another logic, method, and/or system. In various embodiments, logic may include a software controlled microprocessor, discrete logic (e.g., an application specific integrated circuit (ASIC)), a programmed logic device (e.g., a field programmable gate array (FPGA)), a memory device containing instructions, combinations of logic devices, or the like. Logic may include one or more gates, combinations of gates, or other circuit components. Logic may also be fully embodied as software.

In various embodiments of the present disclosure, in addition to any combination of the features described above with respect to the passenger application, application logic 218 may provide additional features for the passenger application to enhance a passenger's experience.

In certain embodiment, the user may have the ability via passenger device 104 to request transportation at a future time, such as “Tomorrow at 8:00 a.m.,” or “45 minutes from now.” When the user makes the request, he may be presented with a proposed minimum price and maximum price, which may be based on the projected fare for the time when the transportation is accepted. The user may then decide whether to accept the proposed price range. If the user fails to accept or reject the proposal within a given time, the request may timeout.

In a particular embodiment, a user may supply login credentials for a social network system (e.g., FACEBOOK) or other social media system (e.g., TWITTER) to the transportation service through application logic 218. The transportation service (e.g., through backend server) may then access the user's account on the social network system or other social media system and access information associated with the user's account. As another example, passenger application logic 218 may access the user's social media account directly and integrate information from the account with other functionality of the passenger application logic.

Social network application logic 222 may provide a user interface to allow a passenger to interact with (e.g., enter and transmit information to and view information received from) a social network system. A social network system may store a record (i.e., a user profile) for each user of the system. The user profile may include any suitable information about the user, such as contact information, employment information, demographic information, personal interests, user-generated content, or other suitable information. The social network system may also store a record of the user's relationship with other users of the social network system. For example, such information may be stored as a social graph, wherein users (e.g., individuals, groups, business entities, organizations, etc.) may be represented as nodes in the graph and the nodes may be connected based on relationships between the users. A social network system may provide various services (e.g., photo sharing, wall posts, messaging, games, or advertisements) facilitating interaction between the users.

In various embodiments, the social network system may interact with passenger application logic 218 or backend system 116 to enhance the functionality of these components. As an example, background information associated with a passenger may be obtained by a backend system 116 and used to determine whether to route a request from the passenger to a particular driver.

In various embodiments, the social network system may provide any of the functionality listed above with respect to passenger application logic 218 in allowing a user to request a ride and may relay received requests for rides to backend system 116 along with any suitable identifying information about the user to facilitate pickup by a driver.

In various embodiments of the present disclosure, in addition to any combination of the features described above with respect to the driver application, driver application logic 220 may provide additional features for the driver application to enhance the functionality of the transportation service.

In some embodiments, when a user requests a future pickup, the transportation service may give a driver an opportunity to “reserve” the job. In that case, driver device 108 may provide to the driver a notification that a new job is available. This may include a proposed minimum rate and maximum rate, and expected rate, which may be based on the projected fare for the job. The driver may then have an opportunity to accept the reservation or not. In some embodiments, reservations may be accepted on a first-come-first-served basis, and if a reservation is not accepted by any driver within a given time, the request may timeout.

FIG. 3 illustrates a block diagram of a backend system 116 of the system of FIG. 1 in accordance with certain embodiments. Although FIG. 3 depicts a particular implementation of the backend system 116, the backend system may include any suitable devices to facilitate the operation of the transportation service described herein. In the embodiment depicted, backend system includes backend server 302, data store 304, and third party services 306 coupled together by network 120h. In various embodiments, backend server 302, data store 304, and/or third party services 306 may each comprise one or more physical devices (e.g., servers or other computing devices) providing the functionality described herein. In some embodiments, one or more of backend server 302, data store 304, and third party services 306 (or portions thereof) are deployed using a cloud service and may comprise one or more virtual machines or containers.

In the embodiment depicted, backend server 302 includes a computer system to facilitate performance of its operations. As an example, backend server 302 includes one or more processors 308, memory elements 310, and communication interfaces 312, among other hardware and software. These components may work together in order to provide backend server functionality described herein. Processor 308 may have any suitable characteristics of the processors 202 and 204 described above. In particular embodiments, backend server 302 may utilize multiple processors to perform the functions described herein. In various embodiments, reference to a processor may refer to multiple discrete processors communicatively coupled together.

Similarly, memory 310 may have any suitable characteristics of memories 206 and 208 described above. Memory 310 may store any suitable data or information utilized by backend server 302, including software embedded in a computer readable medium, and/or encoded logic incorporated in hardware or otherwise stored (e.g., firmware). Memory 310 may also store the results and/or intermediate results of the various calculations and determinations performed by processor 308.

Communication interface 312 may also have any suitable characteristics of communication interfaces 214 and 216 described above. Communication interfaces 312 may be used for the communication of signaling and/or data between backend server 302 and one or more networks (e.g., networks 120) and/or network nodes (e.g., computing devices 104 and 108, data store 304, third party services 306, and application server 112) coupled to a network or other communication channel.

Business logic 314 may have any suitable characteristics of application logic 218 and 220 described above. Business logic 314 may include logic providing, at least in part, the functionality of the backend server described herein. In a particular embodiment, business logic 314 may include software that is executed by processor 308. However, in other embodiments, business logic 314 may take other forms such as those described above with respect to application logic 218 and 220.

Backend server 302 may communicate with data store 304 to initiate storage and retrieval of data related to the transportation service. Data store 304, may store any suitable data associated with the transportation service in any suitable format(s). For example, data store 304 may include one or more database management systems (DBMS), such as SQL Server, Oracle, Sybase, IBM DB2, or NoSQL data bases (e.g., Redis and MongoDB).

In the embodiment depicted, data store 304 includes passenger account data 316, driver account data 318, transportation request data 320, driver availability data 322, navigational data 324, and historical request data 326. The various data may be updated at any suitable intervals.

Passenger account data 316 may include any suitable information associated with passenger accounts, such as contact information (e.g., real names and addresses), user names and passwords (or other authentication information), payment information (e.g., credit card or bank account numbers and associated information), passenger preferences (e.g., preferred type or color of car), ratings the passenger has given drivers, ratings the passenger has received from drivers, or other information associated with passenger profiles.

Driver account data 318 may include any suitable information associated with driver accounts, such as contact information (e.g., real names and addresses), user names and passwords (or other authentication information), payment collection information (e.g., bank account information), vehicle information (e.g., models and colors of cars the drivers utilize, maximum capacity of the cars of the drivers), merchandise offered by the drivers, whether the drivers are available to transport passengers, whether the drivers have opted for automatic acceptance of transportation requests (whereby the backend server 302 may assign a transportation request to the driver without waiting for the driver to indicate acceptance of a request), or other suitable information.

Transportation request data 320 may comprise pending requests (i.e., requests that have not yet been fulfilled) received from passengers. Each request may include any suitable information, such as any combination of one or more of an identification of the passenger making the request, the time the request was made, the current location of the passenger, the desired pick-up location, the desired pick-up time, the estimated time remaining until a driver can pick up the passenger, the actual pick-up time, the desired destination location of the passenger (which the passenger may or may not provide at the time the request is made), the expected arrival time at the destination location, the type of vehicle requested, estimated fare for the trip, current accumulated fare for the trip, estimated time and mileage remaining in the trip, other information specified by the user (e.g., requested merchandise, requested minimum rating of driver), whether a driver has been assigned to a request, and which driver has been assigned to a request.

Driver availability data 322 may comprise information associated with drivers that are available to transport passengers. In some embodiments, driver availability data 322 may also comprise information associated with drivers that are not available to transport passengers (e.g., because they are off-duty or currently transporting a passenger). An entry in the driver availability data 322 may include an identification of a driver and any suitable associated information, such as one or more of a current location of the driver, whether the driver is available to transport passengers, whether the driver is currently transporting a passenger, a destination location of a current trip of the driver, an estimate of how long it will be before the driver finishes his current trip, whether the driver has opted for automatic acceptance of transportation requests, or other suitable information.

Navigational data 324 may comprise information supporting navigation functions provided by the passenger applications and driver passenger applications. For example, navigational data 324 may comprise map data that may be sent to passenger computing devices 104 and driver computing devices 108 to allow the devices to display maps and associated indicators (e.g., location of passenger(s), location of driver(s), desired routes, etc.). In some embodiments, the navigational data may also comprise information indicative of the amount of time required to travel between various locations. In some embodiments, navigational data 324 may comprise historic and/or real time data about the flow of traffic in particular areas enabling backend server 302 to calculate an estimated time required to travel from one location to another.

Historical request data 326 may comprise information about completed requests. In some embodiments, historical request data 326 may also include information about canceled requests. The information for each request may include any combination of the information listed above with respect to requests stored in the transportation request data 320 as well as any combination of additional data such as the time at which the destination location was reached, the total time of the trip, the total fare, a rating given by the passenger to the driver or by the driver to the passenger for the trip, or other suitable information associated with the trip.

In various embodiments, backend server 302 may access third party services 306 through business logic 328 to access data 330. Third party services 306 may represent any suitable number of devices operated by any suitable number of third parties that are distinct from an entity that operates the backend system 116 and/or data store 304. For example, in some embodiments the navigational data may be obtained from a third party service 306 rather than data store 304, or additional third party navigational data such as map data or historical and/or current traffic flow information may be used to supplement navigational data 324. As another example, third party services 306 may authenticate users on behalf of the backend server 302 (e.g., through an account of the user with the third party). Business logic 328 may comprise any suitable logic operable to receive requests for data from backend system 116 and/or computing devices 104 and 108 and provide responses to the requests.

Backend server 302 may be in communication with each passenger computing device 104 and each driver computing device 108 that is utilizing the transportation service at a particular time. Backend server may store information received from the computing devices 104 and 108 in data store 304. Backend server 302 may also receive and respond to requests made by computing devices 104 and 108 by processing information retrieved from data store 304.

When a passenger opens the passenger application, the backend server 302 may log the passenger in based on a comparison of authentication information provided by the passenger computing device 104 with authentication information stored in passenger account data 316. The passenger may then request a ride. The request is received by the backend server 302 and stored in transportation request data 320. Backend server 302 may access driver availability data 322 to determine one or more drivers that would be suitable to fulfill the request from the passenger. In one embodiment, backend server 302 selects a particular driver (e.g., based on the driver's locality with respect to the passenger's pick-up location) and sends information associated with the request to the driver. The driver indicates whether he accepts or rejects the request via his computing device 108. If the driver rejects the request, backend server 302 selects a different driver and the process is repeated until the backend server 302 receives an accepted request from a driver. In another embodiment, backend server 302 may select a plurality of drivers that may fulfill a transportation request and allow the passenger to select one of the drivers. The backend server 302 may proceed to notify the driver of the request in a similar manner to that described above. In yet another embodiment, backend server 302 may select a plurality of drivers that may fulfill a transportation request and notify each driver of the transportation request. The backend server 302 may then allocate the request to one of the drivers based on any suitable criteria. For example, the driver who is the first to accept the request may be assigned to the request. As another example, if multiple drivers accept the request within a given timeframe, the request may be assigned to the most suitable driver (e.g., the driver that is closest to the pick-up location or a driver that has a car that meets preferred characteristics of the transportation request).

Once the request has been accepted by a driver, the backend server 302 notifies the passenger that a driver has accepted his request and provides any suitable information associated with the driver (e.g., driver's current location, model and color of vehicle, estimated time of arrival, etc.) to the passenger.

The backend server 302 may provide navigation information (e.g., the passenger's current location or other pickup location and directions to the current location or other pickup location) to the driver computing device 108 to direct the driver to the passenger's pickup location and subsequently to direct the driver to the passenger's destination location. The backend server 302 may also provide real-time updates associated with the trip to both the passenger and the driver.

Once the passenger's destination location has been reached, the backend server 302 may facilitate payment of the fare for the trip using payment information stored in passenger account data 316 and/or driver account data 318 (or information supplied by the passenger at the time of the transaction). The backend server 302 may also receive ratings associated with the trip for the passenger and driver and store these ratings in data store 304.

In certain embodiments, backend server 302 may have the ability to accept future transportation requests, including providing proposed maximum and minimum prices to passengers, and maximum and minimum rates to drivers. These functions are described in more detail below.

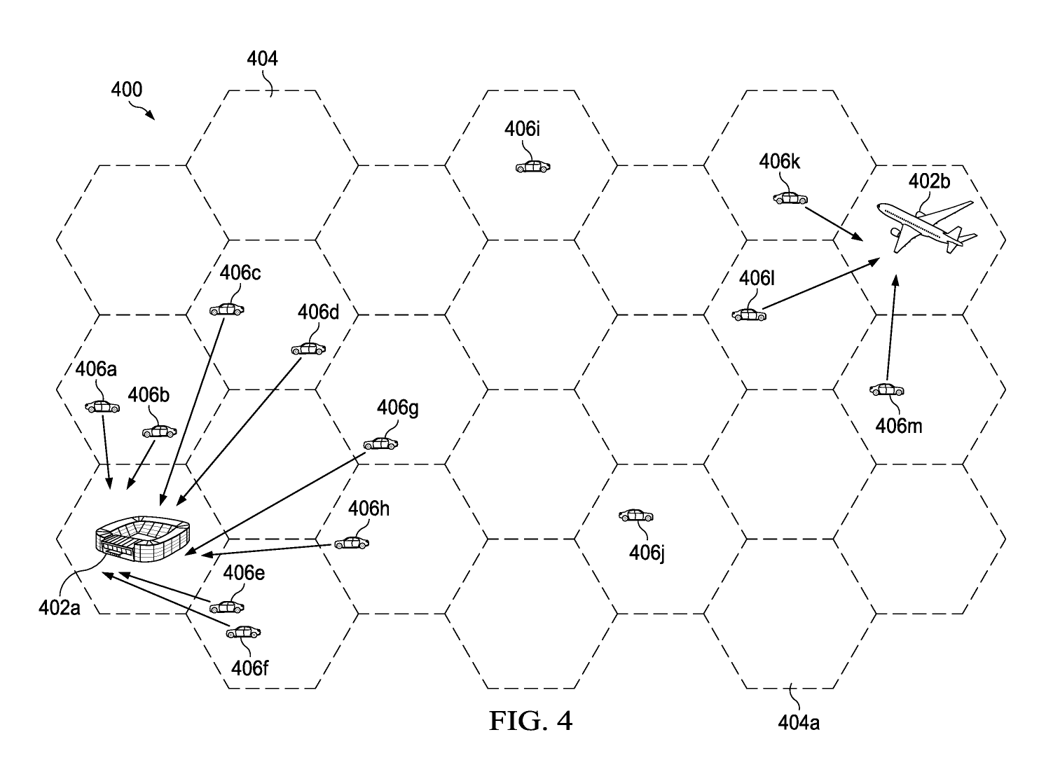

FIG. 4 illustrates a diagram of drivers being directed to various events in accordance with certain embodiments. Although the passenger pick-up regions 404 are depicted as hexagonal regions each having the same area, other embodiments may include passenger pick-up regions with any suitable geographical delineations. In the embodiment depicted, drivers 406 are located in various regions 404. Diagram 400 also depicts event locations 402a and 402b which are the sites of a football game and an arrival of an airplane.

Drivers 406 may be preemptively directed by the backend server 302 to various event locations such that the drivers may be waiting at the event locations when requests from passengers attending the events are received. In the embodiment depicted, drivers 406a-h are directed to wait in separate locations (e.g., the four corners of the football stadium) at the event location to facilitate efficient pairing of passenger requests with the drivers.

In various embodiments, drivers to be preemptively directed to an event may be selected based on their proximity to the event location. For example, in the embodiment depicted, drivers 406a-406h are directed to event location 402a, drivers 706k-m are directed to event location 402b, and drivers 406i and 406j are not directed to an event location.

As described above, the number of drivers directed to an event location may be based on an estimated passenger demand. Various factors may be used to determine whether any particular driver 406 is directed to an event location, such as the driver's proximity to the event location, whether the driver is currently transporting a passenger, the likelihood of the driver picking up a passenger in his current region 404 or other nearby region 404, or other suitable factors. When end times of multiple events occur near the same time and in geographical proximity to each other, backend server may select a subset of available drivers to be directed to a first event and a different subset of the available drivers to be directed to the second event.

As the transportation service operates backend system 116 over time, it may gain greater insight into statistical data. For example, fares may be dynamically calculated based on demand, event locations 402, destinations, trip length, and other factors. A passenger traveling to a popular location at a peak time may pay a substantially higher fare than a passenger traveling at an off-peak hour to a less popular destination. Business logic 314 of backend server 302 may comprise a fare predictor engine, which may rely on heuristic or historical data to predict a probable fare for a particular trip at a particular time. This may include, for example, a calculation of a median, mean, or other average fare, along with fares at different standard deviations or mean absolute deviations.

This model can be used to enable a user to request a reservation for a trip at a future time. For example, a user who resides in a zone 404a may know that he has a flight scheduled tomorrow morning at 9:30, at event 402b (the airport). Thus, the user may request a driver to pick him up at his location 404a at 8:00 a.m. tomorrow and drive him to airport 402b.

Based on heuristic data, business logic 314 may compute that driver 406j or some other driver is likely to be available tomorrow near that time, and that it will take approximately 20 minutes for him to reach the user at location 404a. This may be referred to as a time delta, or the difference between the time a dispatch needs to be provided and the time the driver is likely to arrive at the location 404a. The probability of this being true may be computed to within a threshold value, such as a number of standard deviations, or a percentage probability. If the probability is above a threshold, for example 99%, backend system 116 need not make an explicit reservation with any driver. Rather, at the time delta (in this case, 7:40 a.m.), backend system 116 may issue an ordinary dispatch, with confidence that the request will be fulfilled.

Because the trip is in the future, if dynamic pricing is used the exact fare for the trip may not be known when the user makes the reservation. However, in some cases, a likely fare can be projected with a high degree of confidence. To facilitate the reservation process, the fare may be divided into a passenger price (to be paid by the passenger) and a driver rate (to be paid to the driver). In some embodiments, these need not necessarily match. For example, when the user makes a reservation, the user may be presented with a contractual minimum price and contractual maximum price. Contractually, the user will not pay less than the minimum price for the trip, nor will he pay more than the maximum price. Similarly, if a driver wishes to commit to the reservation, he may be presented with a contractual minimum rate and a contractual maximum rate. The driver will not be paid less than the minimum rate or more than the maximum rate.

The minimum and maximum price and minimum and maximum rate may be any suitable value. In a simplest example, the minimum price is the minimum price projected for the trip for the requested time, and the maximum price is the maximum price projected for the trip for the requested time. The driver may then simply be paid, for his rate, whatever price the customer pays. However, other arrangements may be made to incentivize passengers to use the reservation system, or to incentivize drivers to pick up passengers with reservations.

If the actual fare is in an overlapping region of the user's price range and driver's rate range, then the fare may be charged according to normal practice. However, consider the situation where the fare is above the user's maximum rate but below the driver's maximum rate. In that case, the transportation service may be required to absorb the fare difference. On the other hand, if the price is above the driver's maximum rate and below the user's maximum price, the transportation service may be entitled to collect the fare difference.

In one embodiment, rather than the actual projected minimum, the user's minimum price is set at an average, such as the mean or median rate projected for the time of the trip. The user's maximum price may be set at a commercially-reasonable value, such as approximately 2.5σ (standard deviations) from the average, so that in approximately 99% of cases, the price charged to the user will be greater than or equal to the rate paid to the driver. In this case, the dispatch may simply be issued at the time delta according to normal channels, and the fare may be calculated as normal. In some cases, the user will pay more than he would have paid if he had requested the trip at the time, since his minimum price is the average, and some fares will fall below the average. From the user's perspective, this may be a commercially-reasonable tradeoff for the ability to reserve the trip in advance. Advantageously, in some embodiments where an average is used as the minimum price, a positive psychological correlation may occur. Actual prices will be naturally weighted in favor of the lower end of the price range, so that the user may feel like he is getting a “good deal.” Only rarely will the price creep toward the higher end of the range. In some cases, the maximum price may be deliberately set lower than the statistical value (e.g., 2.5σ) to further act as an incentive for the user to buy.

In other cases, the transportation service will pay a higher rate to the driver than the price collected from the user. This may be a commercially-reasonable tradeoff for the transportation service, because in many cases it will collect a higher price from the user than the rate it pays to the driver.

Advantageously, in the case of a high demand period, a passenger with a reservation will have precedence over new passengers without reservations. Thus, the passenger is more likely to get a ride as desired with an advance reservation. The system provides to the driver adequate compensation to ensure that he will fulfill the reservations. In some cases where demand is high, non-reserved passengers may be blocked from requesting transportation at the same time as reserved passengers because there are insufficient drivers. Those unreserved passengers may be able to request rides only when demand drops off sufficiently. In other embodiments, drivers may be offered a higher rate to pick up passengers with reservations than to pick up passengers without reservations. This incentivizes the drivers to favor picking up passengers with reservations, to ensure that reservations are fulfilled. This is particularly useful in embodiments where specific drivers are not reserved in advance to fulfill advance passenger reservations. In those embodiments, it is commercially beneficial for the transportation system provider to incentivize fulfilling reservations so that its reputation does not suffer from a large number of unfulfilled reservations.

These pricing models and practices are provided by way of nonlimiting example only, and it should be understood that in other embodiments, other pricing models and practices may be used.

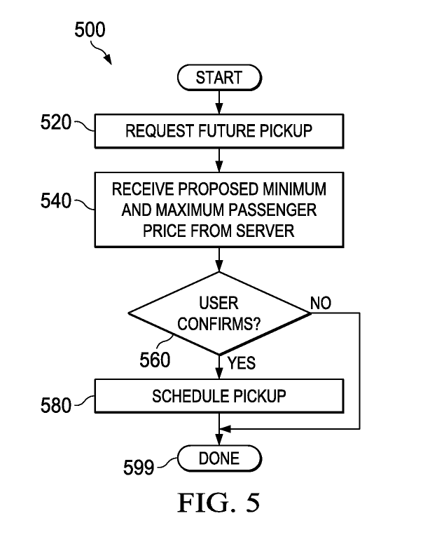

FIG. 5 is a flowchart of a method 500 performed by passenger device 104 according to one or more examples of the present specification.

In block 520, the user may decide that he or she needs a trip with the transportation provider at some future date. For example, the user may know that he has a flight scheduled tomorrow at 9:30, and therefore he needs to be picked up at 8:00 a.m. to make it to the airport. The user operates his passenger device 104 to submit a request to the transportation service for pickup tomorrow morning at 8:00. This request may include, in certain embodiments, the user's contact information, the pickup location, the time of the pickup, and the user's intended destination, by way of nonlimiting example.

In block 540, after passenger device 104 sends the request to backend system 116, passenger device 104 may receive a response back from backend system 116. In block 540, this response may include a proposed minimum and maximum passenger price to be charged to the passenger for the requested trip.

In decision block 560, the user may review the proposed minimum and maximum price, and may determine whether they are acceptable to him. The minimum and maximum price may take one of at least two different forms. The price may be for the full trip (source to destination), in which case a fixed price is negotiated in advance. Or the price may be for a time and/or distance-based fare (e.g., per-minute and/or per-mile), in which case the actual price may depend on traffic, weather, and other conditions that affect the actual distance traveled and the time it takes to travel. In some embodiments the price may be presented as a multiplier of a default or baseline rate, such as 2× the baseline, or 1.5× the baseline.

If the minimum and maximum price are not acceptable, the passenger may operate passenger device 104 to notify backend system 116 that the arrangement is unacceptable. In other examples, if the passenger does not explicitly send a notification either accepting or rejecting the offer, after a time, the offer may automatically expire.

If the passenger accepts the proposed minimum and maximum price and confirms the offer, then in block 580, the passenger sends a notification that he has accepted the offer, and schedules a pickup for the requested time.

In block 599, the method is done.

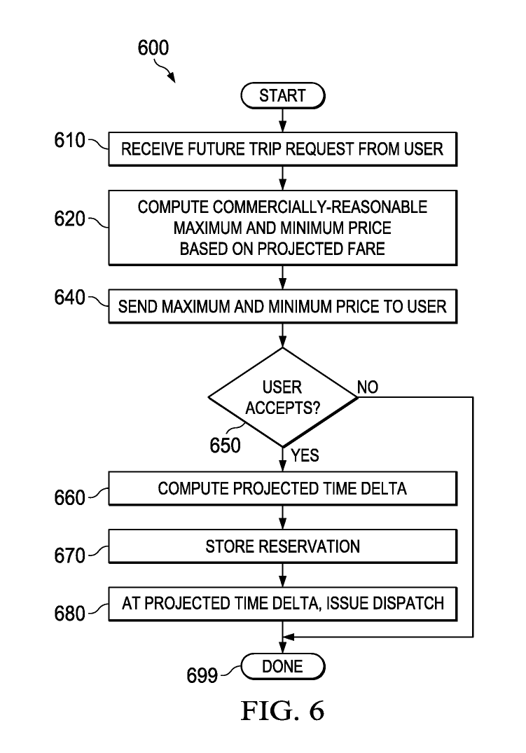

FIG. 6 is a flowchart of a method 600 performed by a backend server 302 according to one or more examples of the present specification. In certain embodiments, business logic 314 of backend server 302 may provide the functionality of method 600.

In block 610, backend server 302 receives from passenger device 104 a request for a future trip. For example, the user may know that he has a flight tomorrow at 9:30 AM, and thus requests pickup for a trip to the airport at 8:00 a.m.

In block 620, backend server 302 computes a commercially reasonable maximum and minimum price range for the requested trip. The maximum and minimum range may be based at least in part on the projected fare. For example, as discussed above, an average projected fare for the requested trip may be computed. In some examples, the average requested fare may be presented as the minimum price to the user. A maximum price may also be computed, such as a price 2.5 standard deviations from the average. In some examples, the maximum price may be deliberately set somewhat lower than this value to further entice the user.

In block 640, backend server 302 sends the maximum and minimum prices to passenger device 104. After a time, backend server 302 may receive a response from passenger device 104. The proposal may have a built-in timeout, so that if user does not respond by a particular time, then the proposal is automatically canceled.

In decision block 650, if the user does not accept proposed maximum and minimum price, then in block 699, the method is done.

However, if the user does accept the proposed price, then in block 660, backend server 302 may project a time delta, for example, based on the number of drivers usually active during the requested time, and the projected time it will take for a driver to reach the user after a dispatch is issued. Backend server 302 may compute that with a high probability, a driver will reach the user within approximately 20 minutes of the dispatch being issued. Thus, the time delta in this situation is 20 minutes. In this example, no formal reservation is made with any particular driver. Rather, in block 670, backend server 300 simply stores the requested reservation.

In block 680, at the time of the projected time Delta, backend server 302 may issue an ordinary dispatch requesting a driver to pick up the passenger at the time delta. In this case, the time delta is 20 minutes, so the dispatch may be issued at approximately 7:40 AM so that it is known, with reasonable confidence, that a driver will reach the user by approximately 8 AM.

In some examples, appropriate padding may be built into the projected time delta. For example, if there is an error margin to the time delta, such as +/−5 minutes, then 5 minutes may be added to the time delta to ensure that a driver reaches the passenger on time. In that case, the dispatch may be issued at 7:35 instead of 7:40. There is a chance that the driver will reach the passenger up to approximately 5 minutes early. In that case, reasonable compensation may be built into the compensation model. For example, the transportation service may pay the driver for the 5 minutes that he may need to wait at the passenger's location. Knowing that this error margin is present, accommodation may be built into the pricing model.

In block 699, the method is done.

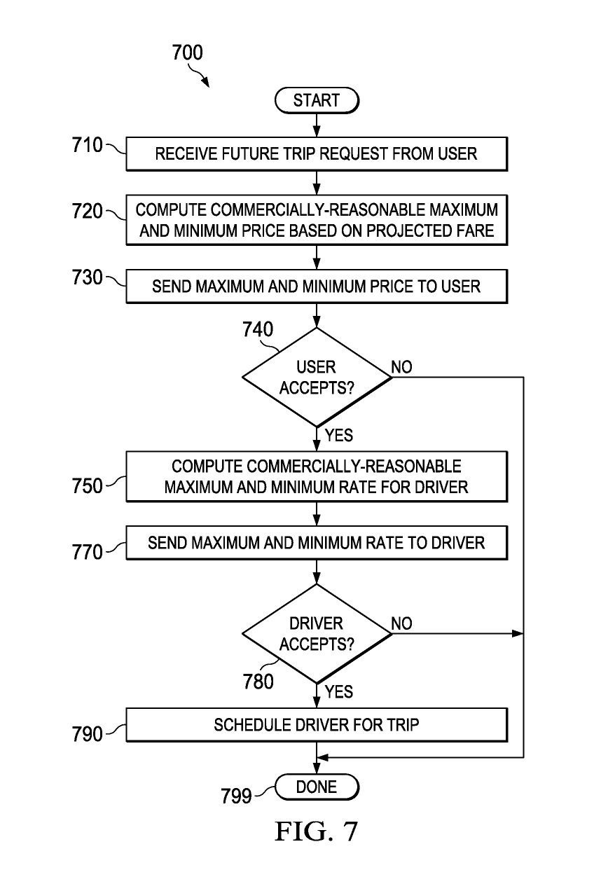

FIG. 7 is a flowchart of a method 700 performed by backend server 302 according to one or more examples of the present specification. In the example of method 700, an explicit reservation may be made with a driver when the passenger requests the reservation.

In block 710, backend server 302 receives from passenger device 104 a request for a future trip. For example, the user may know that he has a flight tomorrow at 9:30 AM, and thus requests pickup for a trip to the airport at 8:00 a.m.

In block 720, backend server 302 computes a commercially reasonable maximum and minimum price range for the requested trip. The maximum and minimum range may be based at least in part on the projected fare. For example, as discussed above, an average projected fare for the requested trip may be computed. In some examples, the average requested fare may be presented as the minimum price to the user. A maximum price may also be computed, such as a price 2.5 standard deviations from the average. In some examples, the maximum price may be deliberately set somewhat lower than this value to further entice the user.

In block 740, backend server 302 sends the maximum and minimum prices to passenger device 104. After a time, backend server 302 may receive a response from passenger device 104. The proposal may have a built-in timeout, so that if user does not respond by a particular time, then the proposal is automatically canceled.

In block 750, backend server 302 may compute a commercially reasonable maximum and minimum rate for the driver. As described above, this maximum and minimum rate need not necessarily match the maximum and minimum price computed for the passenger.

In block 770, backend server 302 sends the maximum and minimum rate proposal to the driver.

In decision block 780, if the driver does not accept, then in block 799, the method is done.

However, if the driver does accept the proposed maximum and minimum rate, then in block 790, backend server 302 may explicitly schedule the driver for the trip. In this case, there may be no compensation offered for a possible time delta as in method 600 of FIG. 6. Rather, the driver in this case is contractually obligated to be at the passenger's location on time, and is not compensated for arriving early.

In block 799, the method is done.

It is also important to note that the steps in FIGS. 5-7 illustrate only some of the possible scenarios that may be executed by, or within, the various components of the system described herein. Some of these steps may be deleted or removed where appropriate, or these steps may be modified or changed considerably without departing from the scope of the present disclosure. In addition, a number of these operations may have been described as being executed concurrently with, or in parallel to, one or more additional operations. However, the timing of these operations may be altered considerably. The preceding operational flows have been offered for purposes of example and discussion.

The functionality described herein may also be performed by any suitable component of the system. For example, certain functionality described herein as being performed by backend server 116, may, in various embodiments, be performed by any combination of one or more passenger computing devices 104 or driver computing devices 108 where appropriate. Similarly, certain functionality described herein as being performed by a passenger computing device 104 or a driver computing device 108 may, in various embodiments, be performed by backend server 116 where appropriate.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
receiving, at a server comprising at least one processor and at least one network interface to communicatively couple the processor to a network, a request from a computing device of a passenger for a trip, the request including a desired future pickup time at a location;
computing a predicted availability of a driver for the future pickup time; and
dispatching the driver to the location to arrive at approximately the pickup time.

2. The method of claim 1, wherein computing the predicted availability comprises computing a predicted time delta between issuing a dispatch notice and the driver arriving at the location.

3. The method of claim 2, wherein dispatching the driver comprises issuing a dispatch notice at the predicted time delta.

4. The method of claim 1, further comprising computing a projected fare for the trip.

5. The method of claim 4, further comprising providing to the passenger a contractual maximum passenger price.

6. The method of claim 5, wherein the contractual maximum passenger price is based at least in part on a projected maximum driver rate for the pickup time, within a threshold of probability.

7. The method of claim 6, wherein the threshold of probability is approximately 99%.

8. The method of claim 4, further comprising providing to the passenger a contractual minimum passenger price.

9. The method of claim 8, wherein the contractual minimum passenger price is a projected median driver rate for the pickup time.

10. The method of claim 1, further comprising enabling the driver to reserve the trip for a contractual minimum rate.

11. The method of claim 10, further comprising providing to the passenger a contractual maximum passenger price, wherein the contractual maximum passenger price does not match the contractual maximum rate.

12. The method of claim 1, further comprising computing for the driver a first rate above a second rate computed for a second passenger, wherein the second passenger lacks a reservation.

13. The method of claim 1, further comprising assigning the passenger priority over a second passenger without a reservation.

14. An apparatus, comprising:
a processor;
a network interface to communicatively couple the processor to a network; and
one or more logic elements comprising a reservation engine operable for:
receiving a request from a computing device of a passenger for a trip, the request including a desired future pickup time at a location;
computing a predicted availability of a driver for the future pickup time; and
dispatching the driver to the location to arrive at approximately the pickup time.

15. The apparatus of claim 14, wherein computing the predicted availability comprises computing a predicted time delta between issuing a dispatch notice and the driver arriving at the location.

16. The apparatus of claim 15, wherein dispatching the driver comprises issuing a dispatch notice at the predicted time delta.

17. The apparatus of claim 14, further comprising computing a projected fare for the trip.

18. The apparatus of claim 17, further comprising providing to the passenger a contractual maximum passenger price.

19. The apparatus of claim 18, wherein the contractual maximum passenger price is based at least in part on a projected maximum driver rate for the pickup time, within a threshold of probability.

20. The apparatus of claim 14, wherein the reservation engine is further operable for providing to the driver a contractual maximum rate, and providing to the passenger a contractual maximum passenger price, wherein the contractual maximum passenger price does not match the contractual maximum rate.

21. One or more tangible, non-transitory computer-readable mediums having stored thereon executable instructions for providing a reservation engine operable for:
receiving, at a server comprising at least one processor and at least one network interface to communicatively couple the processor to a network, a request from a computing device of a passenger for a trip, the request including a desired future pickup time at a location;
computing a predicted availability of a driver for the future pickup time; and
dispatching the driver to the location to arrive at approximately the pickup time.

22. The one or more tangible, non-transitory computer-readable mediums of claim 21, wherein the reservation engine is further operable for computing a projected fare for the trip.
